(19) United States
(12) Patent Application Publication
(10) Pub. No.: US 2024/0417268 A1
(43) Pub. Date: Dec. 19, 2024

(54) METHODS OF FORMING ZSM-5 ZEOLITES FROM HALLOYSITE

(71) Applicants: Saudi Arabian Oil Company, Dhahran (SA); King Fahd University of Petroleum and Minerals, Dhahran (SA)

(72) Inventors: Aaron Akah, Dhahran (SA); Rabindran Jermy, Dammam (SA); Abdullah Aitani, Dhahran (SA); Mohammed A.B. Siddiqui, Dhahran (SA); Musaed Al-Ghrami, Dammam (SA)

(73) Assignees: Saudi Arabian Oil Company, Dhahran (SA); King Fahd University of Petroleum and Minerals, Dhahran (SA)

(21) Appl. No.: 18/334,652

(22) Filed: Jun. 14, 2023

(51) Int. Cl. C01B 39/38; B01J 6/00; B01J 29/40; B01J 35/10; C10G 47/02

(52) U.S. Cl. CPC C01B 39/38; B01J 6/001; B01J 29/40; B01J 35/613; B01J 35/633; B01J 35/635; C10G 47/02; C01P 2006/12; C01P 2006/14

(57) ABSTRACT

This disclosure relates to methods of forming a ZSM-5 zeolite, the method comprising calcining one or more clay mineral compositions to form metakaolin, wherein the one or more clay mineral compositions may comprise greater than or equal to 10 wt. % halloysite; forming a slurry by combining at least the metakaolin, ZSM-5 zeolite seeds, a basic compound, and a silica source; hydrothermally treating the slurry to form a hydrothermal product; and calcining the hydrothermal product to form a ZSM-5 zeolite. This disclosure also relates processes of cracking a hydrocarbon feed comprising contacting the hydrocarbon feed with steam in the presence of a cracking catalyst comprising the ZSM-5 zeolite in a reactor under reaction conditions sufficient to cause at least a portion of the hydrocarbon feed to undergo one or more cracking reactions to produce a cracking effluent comprising light olefins, light aromatic compounds, or both.

### FIELD

The present disclosure generally relates to chemical processing and, more specifically, to zeolite catalyst compositions, methods of making the zeolite catalyst compositions, and methods of cracking hydrocarbons using the zeolite catalyst compositions.

### TECHNICAL BACKGROUND

The worldwide increasing demand for olefins remains a major challenge for many integrated refineries. In particular, the production of some valuable olefins, such as ethylene and propylene, has attracted increased attention as pure olefin streams are considered the building blocks for polymer synthesis. The production of olefins depends on several process variables, such as the feed type, operating conditions, and the type of catalyst used. Many cracking catalysts utilize a zeolite as a support material. However, these cracking catalysts can have limitations with respect to stability and heavy oil conversion. For example, conventional catalysts may have poor polyaromatic cracking conversion. Accordingly, new zeolites and zeolite-based catalysts with various improved attributes are needed.

### BRIEF SUMMARY

There is a need for methods of making zeolite compositions for cracking hydrocarbons. Conventional zeolite compositions can be formed by processes that utilize calcining kaolinite to form metakaolin, prior to making the zeolite composition. Presently discovered, and included in the embodiments described in the present disclosure, are methods in which zeolite compositions are produced by calcining a clay mineral composition having greater than or equal to 10 weight percent halloysite to form metakaolin prior to making the zeolite composition. Such embodiments may yield zeolite compositions that demonstrate improved efficiency in hydrocarbon cracking.

According to one or more embodiments, methods of forming a ZSM-5 zeolite may comprise calcining one or more clay mineral compositions to form metakaolin, where the one or more clay mineral compositions may comprise greater than or equal to 10 wt. % halloysite. The methods may further comprise forming a slurry by combining at least the metakaolin, ZSM-5 zeolite seeds, a basic compound, and a silica source; hydrothermally treating the slurry to form a hydrothermal product; and calcining the hydrothermal product to form the ZSM-5 zeolite.

This summary is provided to introduce a selection of concepts that are further described in the detailed description. This summary is not intended to identify key or essential features of the claimed subject matter, nor is it intended to be used as an aid in limiting the scope of the claimed subject matter.

Additional features and advantages of the described embodiments will be set forth in the detailed description that follows. The additional features and advantages of the described embodiments will be, in part, readily apparent to those skilled in the art from that description or recognized by practicing the described embodiments, including the detailed description that follows as well as the drawings and the claims.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a flow diagram for a method of making a ZSM-5 zeolite, according to one or more embodiments shown and described herein;

FIG. 2 graphically depicts X-ray diffraction spectra for kaolin clay comprising kaolinite and metakaolin formed from calcining the kaolin clay comprising kaolinite, according to the prior art;

FIG. 3 graphically depicts X-ray diffraction spectra for kaolin clay comprising halloysite and metakaolin formed from calcining the kaolin clay comprising halloysite, according to one or more embodiments shown and described herein;

FIG. 4 graphically depicts X-ray diffraction spectra for kaolin clay comprising halloysite and metakaolin formed from calcining the kaolin clay at different calcination durations, according to one or more embodiments shown and described herein;

FIG. 5 graphically depicts pore volume (y-axis) as a function of pore width (x-axis) for metakaolin formed from calcining kaolin clay comprising kaolinite and metakaolin formed from calcining kaolin clay comprising halloysite, according to one or more embodiments shown and described herein;

FIG. 6 graphically depicts nitrogen adsorption-desorption isotherms for metakaolin formed from calcining kaolin clay comprising kaolinite and metakaolin formed from calcining kaolin clay comprising halloysite, according to one or more embodiments shown and described herein;

FIG. 7 graphically depicts X-ray diffraction spectra for ZSM-5 zeolites prepared from kaolin clay comprising halloysite, according to one or more embodiments shown and described herein;

FIG. 8 graphically depicts nitrogen adsorption-desorption isotherms for ZSM-5 zeolites prepared from kaolin clay comprising halloysite, according to one or more embodiments shown and described herein;

FIG. 9 graphically depicts weight loss (y-axis) as a function of temperature (° C.) (x-axis) resulting from thermogravimetric analysis of kaolin clay comprising kaolinite, kaolin clay comprising halloysite, metakaolin formed from calcining the kaolin clay comprising kaolinite, metakaolin formed from calcining the kaolin clay comprising halloysite, and a ZSM-5 zeolite prepared from kaolin clay comprising halloysite, according to one or more embodiments shown and described herein;

FIG. 10 graphically depicts X-ray diffraction spectra for a commercial ZSM-5 zeolite, a ZSM-5 zeolite formed from kaolin clay comprising kaolinite, and a ZSM-5 zeolite formed from kaolin clay comprising halloysite, according to one or more embodiments shown and described herein;

FIG. 11 graphically depicts thermal conductivity detector intensity (y-axis) as a function of temperature (C) (x-axis) resulting from ammonia desorption analysis of metakaolin formed from calcining kaolin clay comprising kaolinite and a ZSM-5 zeolite formed from kaolin clay comprising halloysite, according to one or more embodiments shown and described herein;

FIG. 12 graphically depicts diffuse reflectance spectra comprising absorbance (y-axis) as a function of wavelength (x-axis) for a commercial ZSM-5 zeolite, a ZSM-5 zeolite formed from kaolin clay comprising kaolinite, and a ZSM-5 zeolite formed from kaolin clay comprising halloysite, according to one or more embodiments shown and described herein; and

FIG. 13 is a generalized schematic diagram of a fixed-bed reaction system, according to one or more embodiments shown and described herein.

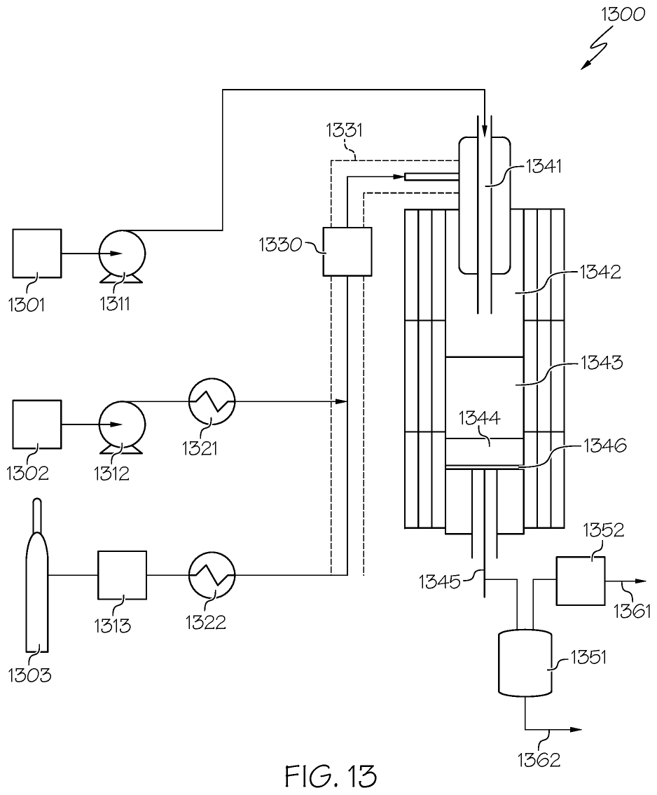

When describing the simplified schematic illustration of FIG. 13, the numerous valves, temperature sensors, electronic controllers, and the like, which may be used and are well known to a person of ordinary skill in the art, may not be depicted. Further, accompanying components that are often included in systems such as that depicted in FIG. 13, such as air supplies, heat exchangers, surge tanks, and the like, also may not be depicted. However, a person of ordinary skill in the art understands that these components are within the scope of the present disclosure.

Additionally, the arrows in the simplified schematic illustration of FIG. 13 refer to process streams. However, the arrows may equivalently refer to transfer lines, which may transfer process streams between two or more system components. Arrows that connect to one or more system components signify inlets or outlets in the given system components and arrows that connect to only one system component signify a system outlet stream that exits the depicted system or a system inlet stream that enters the depicted system. The arrow direction generally corresponds with the major direction of movement of the process stream or the process stream contained within the physical transfer line signified by the arrow.

The arrows in the simplified schematic illustration of FIG. 13 may also refer to process steps of transporting a process stream from one system component to another system component. For example, an arrow from a first system component pointing to a second system component may signify “passing” a process stream from the first system component to the second system component, which may comprise the process stream “exiting” or being “removed” from the first system component and “introducing” or “feeding” the process stream to the second system component.

Reference will now be made in greater detail to various embodiments, some embodiments of which are illustrated in the accompanying drawings.

### DETAILED DESCRIPTION

The present disclosure is directed to methods of forming a ZSM-5 zeolite and processes for cracking hydrocarbon feeds using the resulting ZSM-5 zeolite. In particular, the present disclosure is directed to methods of forming a ZSM-5 zeolite that may include calcining a clay mineral composition to form metakaolin. The clay mineral composition may include greater than or equal to 10 weight percent halloysite. The method may further include forming a slurry by combining the metakaolin formed from calcining the kaolin clay, ZSM-5 zeolite seeds, a basic compound, and a silica source. The method of forming the ZSM-5 zeolite may further include hydrothermally treating the slurry to form a hydrothermal product, and calcining the hydrothermal product to form the ZSM-5 zeolite. A process of the present disclosure for cracking a hydrocarbon feed using the resulting ZSM-5 zeolite may include contacting the hydrocarbon feed with steam in the presence of a cracking catalyst in a reactor under reaction conditions sufficient to cause at least a portion of the hydrocarbon feed to undergo one or more cracking reactions to produce a cracking effluent comprising light olefins, light aromatic compounds, or both. The cracking catalyst may comprise the ZSM-5 zeolite formed from a clay mineral composition comprising greater than or equal to 10 weight percent halloysite.

As used throughout the present disclosure, the term “light olefins” refers to olefin compounds having from 2 to 4 carbon atoms.

As used throughout the present disclosure, the term “light aromatic compounds” refers to compounds having an aromatic ring structure from 6 to 11 carbon atoms, such as benzene, toluene, xylene, or ethylbenzene.

As used throughout the present disclosure, “cracking” generally refers to a chemical reaction where carbon-carbon bonds are broken. For example, a molecule having carbon to carbon bonds is broken into more than one molecule by the breaking of one or more of the carbon to carbon bonds, or is converted from a compound which includes a cyclic moiety, such as a cycloalkane, cycloalkane, naphthalene, an aromatic or the like, to a compound which does not include a cyclic moiety or contains fewer cyclic moieties than prior to cracking.

It should be understood that a “product effluent” generally refers to a stream that exits a system component such as a reactor or reactor zone, following a particular reaction, and generally has a different composition (at least proportionally) than the stream that entered the reactor or reaction zone, such as the hydrocarbon feed.

As used throughout the present disclosure, a “reactor” refers to a vessel in which one or more chemical reactions may occur between one or more reactants optionally in the presence of one or more catalysts.

As used throughout the present disclosure, a “reaction zone” refers to an area where a particular reaction takes place in a reactor.

As used throughout the present disclosure, the term “residence time” refers to the amount of time that reactants are in contact with a catalyst, at reaction conditions, such as at the reaction temperature.

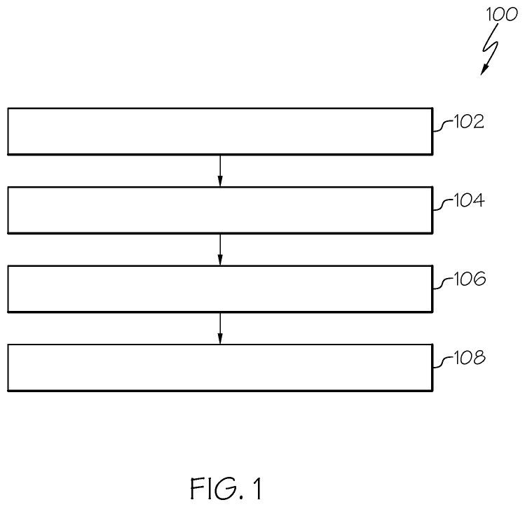

Referring now to FIG. 1, a method 100 of forming a ZSM-5 zeolite is depicted. As depicted, FIG. 1 includes a series of “blocks” which are each representative of one or more steps in the method presently described. Generally, the method steps, indicated and sometimes referred to as blocks herein, are ordered as depicted in FIG. 1. The method of FIG. 1 generally includes calcining one or more clay mineral compositions to form metakaolin (at block 102); forming a slurry by combining at least the metakaolin, ZSM-5 zeolite seeds, a basic compound, and a silica source (at block 104); hydrothermally treating the slurry to form a hydrothermal product (at block 106); and calcining the hydrothermal product to form the ZSM-5 zeolite (at block 108).

As described herein, at block 102, the method may include calcining one or more clay mineral compositions to form metakaolin. Calcining may comprise heating a material to an elevated temperature, and holding the temperature of the material at an elevated temperature for a duration of time in an environment comprising oxygen. A clay mineral composition may comprise one or more clay minerals, such as kaolinite and halloysite. In embodiments, two or more clay mineral compositions may be used. That is, in embodiments, at least two separate clay mineral compositions comprising a different weight percentage of clay minerals may be used as described herein. When a weight percentage of a specific clay mineral, such as halloysite, is provided for the “one or more clay mineral compositions”, the weight percentage refers to the weight of the specific clay mineral in relation to the summation of the one or more clay mineral compositions, unless specified otherwise.

In embodiments, the one or more clay mineral compositions may comprise kaolin. As used herein, “kaolin” or “kaolin clay” refers to a class of clay minerals comprising the chemical formula Al₂Si₂O₅(OH)₄, which may include the clay minerals kaolinite, halloysite, dickite, and nacrite. In embodiments, the one or more clay mineral compositions may comprise halloysite, kaolinite, dickite, nacrite or combinations thereof. Kaolinite has the chemical formula Al₂Si₂O₅(OH)₄, and may occur in platy forms. Halloysite has a similar composition to kaolinite except that halloysite may naturally occur as small cylinders and may have additional water molecules. In its fully hydrated form, halloysite has additional water molecules between layers of the crystal structure and has a chemical formula of Al₂Si₂Os (OH)₄·2H₂O. Halloysite may also be partially dehydrated, meaning that at least a portion of the water molecules have been removed from the halloysite structure. As used herein, the term “halloysite” is used to refer to both the fully hydrated and partially hydrated forms of halloysite, unless specified otherwise.

In embodiments, the one or more clay mineral compositions may comprise greater than or equal to 10 weight percent (wt. %) halloysite, such as greater than or equal to 15 wt. %, greater than or equal to 20 wt. %, greater than or equal to 25 wt. %, greater than or equal to 30 wt. %, greater than or equal to 35 wt. %, greater than or equal to 40 wt. %, greater than or equal to 45 wt. %, greater than or equal to 50 wt. %, greater than or equal to 55 wt. %, greater than or equal to 60 wt. %, greater than or equal to 65 wt. %, greater than or equal to 70 wt. %, greater than or equal to 75 wt. %, greater than or equal to 80 wt. %, greater than or equal to 85 wt. %, greater than or equal to 90 wt. %, greater than or equal to 95 wt. %, greater than or equal to 99 wt. %, or even greater than or equal to 99.99 wt. % halloysite, based on the total weight of the one or more clay mineral compositions. In embodiments, the one or more clay mineral compositions may comprise of from 10 wt. % to 100 wt. % halloysite, such as from 20 wt. % to 100 wt. %, from 30 wt. % to 100 wt. %, from 40 wt. % to 100 wt. %, from 50 wt. % to 100 wt. %, from 60 wt. % to 100 wt. %, from 70 wt. % to 100 wt. %, from 80 wt. % to 100 wt. %, from 90 wt. % to 100 wt. %, from 10 wt. % to 90 wt. %, from 20 wt. % to 90 wt. %, from 30 wt. % to 90 wt. %, from 40 wt. % to 90 wt. %, from 50 wt. % to 90 wt. %, from 60 wt. % to 90 wt. %, from 70 wt. % to 90 wt. %, from 80 wt. % to 90 wt. %, from 10 wt. % to 80 wt. %, from 20 wt. % to 80 wt. %, from 30 wt. % to 80 wt. %, from 40 wt. % to 80 wt. %, from 50 wt. % to 80 wt. %, from 60 wt. % to 80 wt. %, from 70 wt. % to 80 wt. %, from 10 wt. % to 70 wt. %, from 20 wt. % to 70 wt. %, from 30 wt. % to 70 wt. %, from 40 wt. % to 70 wt. %, from 50 wt. % to 70 wt. %, from 60 wt. % to 70 wt. %, from 10 wt. % to 60 wt. %, from 20 wt. % to 60 wt. %, from 30 wt. % to 60 wt. %, from 40 wt. % to 60 wt. %, from 50 wt. % to 60 wt. %, from 10 wt. % to 50 wt. %, from 20 wt. % to 50 wt. %, from 30 wt. % to 50 wt. %, from 40 wt. % to 50 wt. %, from 10 wt. % to 40 wt. %, from 20 wt. % to 40 wt. %, from 30 wt. % to 40 wt. %, from 10 wt. % to 30 wt. %, from 20 wt. % to 30 wt. %, or from 10 wt. % to 20 wt. % halloysite, based on the total weight of the one or more clay mineral compositions.

In embodiments, the one or more clay mineral compositions may comprise less than or equal to 90 weight percent (wt. %) kaolinite, such as less than or equal 50 wt. %, less than or equal to 20 wt. %, less than or equal to 10 wt. %, less than or equal to 5 wt. %, less than or equal to 2 wt. %, less than or equal to 1 wt. %, less than or equal to 0.5 wt. %, or even less than or equal to 0.1 wt. % kaolinite, based on the total weight of the one or more clay mineral compositions. In embodiments, the one or more clay mineral compositions may comprise of from 0 wt. % to 90 wt. % kaolinite, such as from 0 wt. % to 80 wt. %, from 0 wt. % to 70 wt. %, from 0 wt. % to 60 wt. %, from 0 wt. % to 50 wt. %, from 0 wt. % to 40 wt. %, from 0 wt. % to 30 wt. %, from 0 wt. % to 20 wt. %, from 0 wt. % to 10 wt. %, from 0 wt. % to 5 wt. %, from 0 wt. % to 2 wt. %, from 0 wt. % to 1 wt. %, or from 0 wt. % to 0.5 wt. % kaolinite, based on the total weight of the one or more clay mineral compositions.

Without intending to be bound by any particular theory, it is believed that using one or more clay mineral compositions having a greater amount of halloysite, such as greater than or equal to 10 wt. % halloysite, in the methods described in the present disclosure may provide a ZSM-5 zeolite having improved properties, such as but not limited to increased surface area compared to methods using one or more clay minerals having less than 10 wt. % halloysite.

In embodiments, the one or more clay minerals may be naturally occurring. As used herein, “naturally occurring” refers to clay minerals that are not synthesized. In embodiments, the naturally occurring clay minerals may be processed. For instance, the clay minerals may be processed to remove impurities. Without intending to be bound by any particular theory, it is believed that the use of clay minerals that are naturally occurring may improve the environmental footprint of the methods disclosed in the present disclosure compared to using clay minerals that are synthesized.

In embodiments, calcining the clay minerals may comprise heating the clay minerals at a temperature of greater than or equal to 550° C., such as greater than or equal to 600° C., or greater than or equal to 650° C. In embodiments, calcining the one or more clay minerals may comprise heating the one or more clay minerals at a temperature of from 550° C. to 900° C., such as from 550° C. to 800° C., from 550° C. to 750° C., from 600° C. to 900° C., from 600° C. to 800° C., from 600° C. to 750° C., from 650° C. to 900° C., from 650° C. to 800° C., or from 650° C. to 750° C. In embodiments, calcining the one or more clay minerals may comprise heating the one or more clay minerals for a duration of greater than or equal to 10 minutes (min), such as greater than or equal to 30 min, greater than or equal to 60 min, or greater than or equal to 90 min. In embodiments, calcining the one or more clay minerals may comprise heating the one or more clay minerals for a duration of from 10 min to 2 days.

In embodiments, through calcination, at least a portion of the clay mineral compositions may be converted to metakaolin. As used herein, “metakaolin” refers to a compound comprising chemical formula Al₂Si₂O₇. Metakaolin may be formed by heating kaolin, such as one or more clay mineral compositions comprising kaolinite, halloysite, or combinations thereof to an elevated temperature for a duration of time. In embodiments, changes in properties of the one or more clay mineral compositions may result in changes in properties of the metakaolin derived from calcining the clay mineral compositions. That is, the clay mineral compositions comprising an increased amount of halloysite, such as greater than or equal to 10 wt. % halloysite, may be converted to metakaolin having at least one or more different properties, such as different average surface area or different average pore volume, compared to metakaolin derived from one or more clay mineral compositions having less than 10 wt. % halloysite.

Surface area, pore volume, average pore size, and pore size distribution may be measured by nitrogen (N₂) adsorption isotherms performed at 77 Kelvin (K) (such as with a Micrometrics ASAP 2020 system). As would be understood by those skilled in the art, Brunauer, Emmett, and Teller (BET) analysis methods may be utilized to calculate the surface area from the N₂ adsorption isotherms, and the Barrett, Joyner and Halenda (BJH) calculation may be used to determine pore volume and pore size distribution from the N₂ adsorption isotherms.

In embodiments, the metakaolin produced from calcining the clay mineral compositions may have a surface area of greater than or equal to 30 m²/g, such as greater than or equal to 35 m²/g, greater than or equal to 40 m²/g, greater than or equal to 45 m²/g, greater than or equal to 50 m²/g, greater than or equal to 55 m²/g, or even greater than or equal to 60 m²/g. In embodiments, the metakaolin may have a surface area of from 10 m²/g to 100 m²/g. For instance, in embodiments, the metakaolin may have a surface area of from 20 m²/g to 100 m²/g, from 30 m²/g to 100 m²/g, from 40 m²/g to 100 m²/g, from 50 m²/g to 100 m²/g, from 60 m²/g to 100 m²/g, from 10 m²/g to 80 m²/g, from 20 m²/g to 80 m²/g, from 30 m²/g to 80 m²/g, from 40 m²/g to 80 m²/g, from 50 m²/g to 80 m²/g, or from 60 m²/g to 80 m²/g. The surface area is determined using BET analysis.

In embodiments, the metakaolin produced from calcining the clay mineral compositions may have an average pore volume of greater than or equal to 0.15 cm³/g, such as greater than or equal to 0.20 cm³/g, greater than or equal to 0.25 cm³/g, or greater than or equal to 0.30 cm³/g. In embodiments, the metakaolin may have an average pore volume of from 0.1 cm³/g to 0.5 cm³/g. For instance, in embodiments, the metakaolin may have an average pore volume of from 0.2 cm³/g to 0.5 cm³/g, or from 0.3 cm³/g to 0.5 cm³/g. In embodiments, the metakaolin may have an average pore diameter of from 0.5 nm to 50 nm. The average pore volume and the average pore diameter are determined using BJH analysis.

Referring again to FIG. 1, as described herein, at block 104, the method may include forming a slurry comprising the metakaolin that has been produced through calcining the clay mineral compositions. In embodiments, forming the slurry may include combining at least the metakaolin, ZSM-5 zeolite seeds, a basic compound, and a silica source.

The ZSM-5 zeolite seeds may be active to catalytically crack hydrocarbon compounds. As used in the present disclosure, “ZSM-5” or “ZSM-5 zeolites” refers to zeolites having an MFI framework type according to the IUPAC zeolite nomenclature and consisting of silica and alumina. ZSM-5 refers to “Zeolite Socony Mobil-5” and is a pentasil family zeolite that can be represented by the chemical formula NaₙAlₙSi₉₆₋ₙO₁₉₂·16H₂O, where 0<n<27. “ZSM-5 zeolite seeds” refers to preformed ZSM-5 zeolites that are present in the slurry of the present disclosure, which may direct the formation of the ZSM-5 zeolite in the methods described in the present disclosure.

In embodiments, the ZSM-5 zeolite seeds may have a silica to alumina weight ratio (SAR) of from 10 to 280, such as from 10 to 200, from 10 to 150, from 10 to 100, from 50 to 280, from 50 to 200, from 50 to 150, or from 50 to 100.

In embodiments, the ZSM-5 zeolite seeds may have a surface area of greater than or equal to 200 m²/g, such as greater than or equal to 250 m²/g, greater than or equal to 300 m²/g, or greater than or equal to 350 m²/g. In embodiments. The ZSM-5 zeolite seeds may have a surface area of from 200 m²/g to 500 m²/g, from 200 m²/g to 400 m²/g, from 200 m²/g to 375 m²/g, from 250 m²/g to 500 m²/g, from 250 m²/g to 400 m²/g, from 250 m²/g to 375 m²/g, from 300 m²/g to 500 m²/g, from 300 m²/g to 400 m²/g, from 300 m²/g to 375 m²/g, from 350 m²/g to 500 m²/g, from 350 m²/g to 400 m²/g, or from 350 m²/g to 375 m²/g. The surface area is determined using BET analysis.

In embodiments, the ZSM-5 zeolite seeds may have an average total pore volume of greater than or equal to 0.10 cm³/g, such as greater than or equal to 0.15 cm³/g, or greater than or equal to 0.20 cm³/g. In embodiments, the ZSM-5 zeolite seeds may have an average total pore volume of less than 0.35 cm³/g, less than 0.30 cm³/g, or less than 0.25 cm³/g. In embodiments, the ZSM-5 zeolite seeds may have an average total pore volume of from 0.1 cm³/g to 0.5 cm³/g. For instance, in embodiments, the ZSM-5 zeolite seeds may have an average total pore volume of from 0.1 cm³/g to 0.4 cm³/g, from 0.1 cm³/g to 0.3 cm³/g from 0.1 cm³/g to 0.25 cm³/g, from 0.15 cm³/g to 0.4 cm³/g, from 0.15 cm³/g to 0.3 cm³/g, from 0.15 cm³/g to 0.25 cm³/g, from 0.2 cm³/g to 0.4 cm³/g, from 0.2 cm³/g to 0.3 cm³/g, or from 0.2 cm³/g to 0.25 cm³/g. The average total pore volume is determined using BJH analysis.

In embodiments, the basic compound may be any basic compound. In embodiments, the basic compound may comprise sodium hydroxide. In embodiments, the basic compound may comprise sodium carbonate. Without intending to be bound by any particular theory, it is believed that the basic compound may facilitate dissolution of the silica source in the slurry.

In embodiments, the silica source may be any source comprising silica. In embodiments, the silica source may comprise colloidal silica.

In embodiments, the slurry may comprise of from 0.5 wt. % to 5 wt. % of the metakaolin, based on the total weight of the slurry. For instance, the slurry may comprise of from 0.5 wt. % to 5 wt. %, from 0.5 wt. % to 4 wt. %, from 0.5 wt. % to 3 wt. %, from 0.5 wt. % to 2 wt. %, from 0.5 wt. % to 1 wt. %, from 1 wt. % to 5 wt. %, from 1 wt. % to 4 wt. %, from 1 wt. % to 3 wt. %, from 1 wt. % to 2 wt. %, from 2 wt. % to 5 wt. %, from 2 wt. % to 4 wt. %, from 2 wt. % to 3 wt. %, from 3 wt. % to 5 wt. %, from 3 wt. % to 4 wt. %, or from 4 wt. % to 5 wt. % of the metakaolin, based on the total weight of the slurry.

In embodiments, the slurry may comprise of from 0.01 wt. % to 5 wt. % of the ZSM-5 zeolite seeds, based on the total weight of the slurry. For instance, the slurry may comprise from 0.01 wt. % to 5 wt. %, from 0.01 wt. % to 4 wt. %, from 0.01 wt. % to 3 wt. %, from 0.01 wt. % to 2 wt. %, from 0.01 wt. % to 1 wt. %, from 0.01 wt. % to 0.5 wt. %, from 0.01 wt. % to 0.2 wt. %, from 0.1 wt. % to 5 wt. %, from 0.1 wt. % to 4 wt. %, from 0.1 wt. % to 3 wt. %, from 0.1 wt. % to 2 wt. %, from 0.1 wt. % to 1 wt. %, from 0.5 wt. % to 5 wt. %, from 0.5 wt. % to 4 wt. %, from 0.5 wt. % to 3 wt. %, from 0.5 wt. % to 2 wt. %, from 0.5 wt. % to 1 wt. %, from 1 wt. % to 5 wt. %, from 1 wt. % to 4 wt. %, from 1 wt. % to 3 wt. %, from 1 wt. % to 2 wt. %, from 2 wt. % to 5 wt. %, from 2 wt. % to 4 wt. %, from 2 wt. % to 3 wt. %, from 3 wt. % to 5 wt. %, from 3 wt. % to 4 wt. %, or from 4 wt. % to 5 wt. % of the ZSM-5 zeolite seeds, based on the total weight of the slurry.

In embodiments, the slurry may comprise of from 0.5 wt. % to 4 wt. % of the basic compound, based on the total weight of the slurry. For instance, the slurry may comprise from 0.5 wt. % to 4 wt. %, from 0.5 wt. % to 3 wt. %, from 0.5 wt. % to 2 wt. %, from 0.5 wt. % to 1 wt. %, from 1 wt. % to 4 wt. %, from 1 wt. % to 3 wt. %, from 1 wt. % to 2 wt. %, from 2 wt. % to 4 wt. %, or from 2 wt. % to 3 wt. % of the basic compound, based on the total weight of the slurry. In embodiments the slurry may comprise from 0.5 wt. % to 4 wt. %, from 0.5 wt. % to 3 wt. %, from 0.5 wt. % to 2 wt. %, from 0.5 wt. % to 1 wt. %, from 1 wt. % to 4 wt. %, from 1 wt. % to 3 wt. %, from 1 wt. % to 2 wt. %, from 2 wt. % to 4 wt. %, or from 2 wt. % to 3 wt. % of NaOH, based on the total weight of the slurry.

In embodiments, the slurry may comprise of from 5 wt. % to 60 wt. % of the silica source, based on the total weight of the slurry. For instance, the slurry may comprise from 5 wt. % to 50 wt. %, from 5 wt. % to 40 wt. %, from 5 wt. % to 30 wt. %, from 5 wt. % to 20 wt. %, from 10 wt. % to 60 wt. %, from 10 wt. % to 50 wt. %, from 10 wt. % to 40 wt. %, from 10 wt. % to 30 wt. %, from 10 wt. % to 20 wt. %, from 20 wt. % to 60 wt. %, from 20 wt. % to 50 wt. %, from 20 wt. % to 40 wt. %, from 20 wt. % to 30 wt. %, from 30 wt. % to 60 wt. %, from 30 wt. % to 50 wt. %, or from 35 wt. % to 45 wt. % of the silica source., based on the total weight of the slurry.

In embodiments, the slurry may further comprise a templating agent. In embodiments, the templating agent may comprise an ammonium salt, such as but not limited to tetrapropylammonium bromide (TPABr) or centrimonium bromide (CTAB). In embodiments, the ammonium salt may be a bromide salt. In embodiments. The templating agent may comprise a poloxamer, such as but not limited to Pluronic® F-127 and Pluronic® P-123, commercially available from BASF Corporation. As used herein, the term “poloxamer” may refer to a triblock copolymer comprising a central hydrophobic chain of poly (propylene oxide) and two hydrophilic chains of poly (ethylene oxide). In embodiments, the templating agent may comprise an ammonium salt, a poloxamer, or combinations thereof. In embodiments, the templating agent may be selected from an ammonium salt, a poloxamer, and combinations thereof.

In embodiments, the slurry may comprise of from 0 wt. % to 3 wt. % of the templating agent, based on the total weight of the slurry. For instance, the slurry may comprise from 0.5 wt. % to 3 wt. %, from 0.5 wt. % to 2 wt. %, from 0.5 wt. % to 1 wt. %, from 1 wt. % to 3 wt. %, from 1 wt. % to 2 wt. %, or from 2 wt. % to 3 wt. % of the templating agent, based on the total weight of the slurry. In embodiments, the slurry may not include the templating agent.

Referring again to FIG. 1, as previously discussed, at block 106, the method of making the ZSM-5 zeolite may include hydrothermally treating the slurry to form a hydrothermal product. Hydrothermally treating the slurry may include heating the slurry to a hydrothermal treatment temperature in the presence of steam and maintaining the slurry at the hydrothermal temperature for a period of time. In embodiments, hydrothermally treating the slurry may be conducted in the presence of steam with less than 2 wt. % oxygen gas (O₂) present during the hydrothermal treatment. In embodiments, hydrothermally treating the slurry may include heating the slurry at a temperature of greater than or equal to 100° C., such as greater than or equal to 125° C., greater than or equal to 150° C., or even greater than or equal to 170° C. In embodiments, hydrothermally treating the slurry may include heating the slurry at a temperature of from 100° C. to 200° C. In embodiments, hydrothermally treating the slurry may include heating the slurry in an autoclave and maintaining the slurry at the hydrothermal treatment temperature in the autoclave. Without intending to be bound by any particular theory, it is believed that heating the slurry at a temperature greater than 200° C. may change the phase of the shape selective zeolite or affect the shape and/or size of the shape selective zeolite.

In embodiments, hydrothermally treating the slurry may include heating the slurry for a duration of greater than or equal to 1 hour (hr), such as greater than or equal to 3 hr, greater than or equal to 6 hr, greater than or equal to 12 hr, greater than or equal to 24 hr, greater than or equal to 48 hr, greater than or equal to 72 hr, or greater than or equal to 96 hr. In embodiments, hydrothermally treating the slurry may include heating the slurry for a duration of from 1 hr to 5 days. Without intending to be bound by any particular theory, it is believed that increasing the duration that the slurry is hydrothermally treated may increase the mesopore surface area, the micropore surface area, or both the mesopore surface and micropore surface area of the ZSM-5 zeolite formed therefrom. Such increase in the surface area of the ZSM-5 zeolite may result in increasing a yield of propylene from the cracking of crude oil over the ZSM-5 zeolite of the present disclosure.

In embodiments, the hydrothermal product may be separated from the slurry after hydrothermal treatment. Methods known in the art may be used to separate the hydrothermal product from the slurry, such as but not limited to decantation, filtration, vacuum filtration, or other solid-liquid separation methods. After separation, the hydrothermal product may be washed with a solution, such as water. Washing may remove excess reagents from the surface of the hydrothermal product.

Referring again to FIG. 1, at block 108, the method may include calcining the hydrothermal product to form the ZSM-5 zeolite. In embodiments, calcining the hydrothermal product may comprise heating the hydrothermal product at a temperature of greater than or equal to 400° C., such as greater than or equal to 450° C., greater than or equal to 475° C., or greater than or equal to 500° C. In embodiments, calcining the hydrothermal product may comprise heating the hydrothermal product at a temperature of from 400° C. to 700° C., such as from 400° C. to 600° C., from 500° C. to 700° C., or from 500° C. to 600° C. In embodiments, calcining the hydrothermal product may include heating the hydrothermal product for a duration of greater than or equal to 10 min, greater than or equal to 30 min, or greater than or equal to 2 hr. In embodiments, calcining the hydrothermal product may comprise heating the hydrothermal product for a duration of from 10 min to 12 hr, such as 6 hr.

In embodiments, the ZSM-5 zeolite may be subjected to an ion exchange process to convert the ZSM-5 zeolite to the hydrogen form of the ZSM-5 zeolite, which is referred to in the present disclosure as the HZSM-5 zeolite. In embodiments, the ZSM-5 zeolite may be subjected an ion exchange process by contacting the ZSM-5 zeolite with a solution comprising ammonium nitrate (NH₄NO₃) or ammonium acetate. In embodiments, the ion exchange process conditions may include contacting the ZSM-5 zeolite with a solution having a concentration of about 1 molar (M) and in an amount from 1 milliliter (mL) to 100 mL of the solution per 1 gram (g) of the ZSM-5 zeolite, such as 10 mL of the about 1 M solution per 1 g of the ZSM-5 zeolite. In embodiments, the ion exchange process may include contacting the ZSM-5 zeolite with the solution for a duration of at least 10 minutes, such as about 3 hours.

In embodiments where the ZSM-5 zeolite is subjected to the ion exchange process, the ZSM-5 zeolite may be calcined after the ion exchange process.

In embodiments, calcining the ZSM-5 zeolite may comprise heating the ZSM-5 zeolite at a temperature of greater than or equal to 400° C., such as greater than or equal to 450° C., or greater than or equal to 475° C. In embodiments, calcining the ZSM-5 zeolite may comprise heating the ZSM-5 zeolite at a temperature of from 400° C. to 700° C., such as from 400° C. to 600° C., or from 400° C. to 550° C.

In embodiments, calcining the ZSM-5 zeolite may comprise heating the ZSM-5 zeolite for a duration of greater than or equal to 10 min, greater than or equal to 30 min, or greater than or equal to 2 hr. In embodiments, calcining the ZSM-5 zeolite may comprise heating the ZSM-5 zeolite for a duration of from 10 min to 6 hr.

In embodiments, the ZSM-5 zeolite may have a surface area of greater than or equal to 100 m²/g, such as greater than or equal to 150 m²/g, greater than or equal to 175 m²/g, greater than or equal to 200 m²/g, greater than or equal to 225 m²/g, greater than or equal to 250 m²/g, or even greater than or equal to 255 m²/g. In embodiments, the ZSM-5 zeolite may have a surface area of from 100 m²/g to 400 m²/g. For instance, in embodiments, the ZSM-5 zeolite may have a surface area of from 150 m²/g to 400 m²/g, from 200 m²/g to 400 m²/g, from 225 m²/g to 400 m²/g, from 250 m²/g to 400 m²/g, from 255 m²/g to 400 m²/g, from 100 m²/g to 300 m²/g, from 150 m²/g to 300 m²/g, from 200 m²/g to 300 m²/g, from 225 m²/g to 300 m²/g, from 250 m²/g to 300 m²/g, or from 255 m²/g to 300 m²/g. The surface area is determined using BET analysis.

In embodiments, the ZSM-5 zeolite may have an average mesopore volume of greater than or equal to 0.05 cm³/g, such as greater than or equal to 0.06 cm³/g, greater than or equal to 0.07 cm³/g, greater than or equal to 0.08 cm³/g, greater than or equal to 0.09 cm³/g, greater than or equal to 0.10 cm³/g, greater than or equal to 0.11 cm³/g, greater than or equal to 0.12 cm³/g, greater than or equal to 0.13 cm³/g, greater than or equal to 0.14 cm³/g, or greater than or equal to 0.15 cm³/g. In embodiments, the ZSM-5 zeolite may have an average mesopore volume of from 0.05 cm³/g to 2.0 cm³/g. For instance, in embodiments, the ZSM-5 zeolite may have an average mesopore volume of from 0.06 cm³/g to 3.0 cm³/g, from 0.07 cm³/g to 3.0 cm³/g, from 0.08 cm³/g to 3.0 cm³/g, from 0.09 cm³/g to 3.0 cm³/g, from 0.10 cm³/g to 3.0 cm³/g, from 0.11 cm³/g to 3.0 cm³/g, from 0.12 cm³/g to 3.0 cm³/g, from 0.13 cm³/g to 3.0 cm³/g, from 0.14 cm³/g to 3.0 cm³/g, from 0.15 cm³/g to 3.0 cm³/g, from 0.05 cm³/g to 2.0 cm³/g, from 0.06 cm³/g to 2.0 cm³/g, from 0.07 cm³/g to 2.0 cm³/g, from 0.08 cm³/g to 2.0 cm³/g, from 0.09 cm³/g to 2.0 cm³/g, from 0.10 cm³/g to 2.0 cm³/g, from 0.11 cm³/g to 2.0 cm³/g, from 0.12 cm³/g to 2.0 cm³/g, from 0.13 cm³/g to 2.0 cm³/g, from 0.14 cm³/g to 2.0 cm³/g, or from 0.15 cm³/g to 2.0 cm³/g. The average pore volume is determined using BJH analysis.

In embodiments, the ZSM-5 zeolite may have an average micropore volume of greater than or equal to 0.05 cm³/g, such as greater than or equal to 0.06 cm³/g, greater than or equal to 0.07 cm³/g, greater than or equal to 0.08 cm³/g, greater than or equal to 0.09 cm³/g, or greater than or equal to 0.10 cm³/g. In embodiments, the ZSM-5 zeolite may have an average micropore volume of from 0.05 cm³/g to 2.0 cm³/g. For instance, in embodiments, the ZSM-5 zeolite may have an average micropore volume of from 0.06 cm³/g to 2.0 cm³/g, from 0.07 cm³/g to 2.0 cm³/g, from 0.08 cm³/g to 2.0 cm³/g, from 0.09 cm³/g to 2.0 cm³/g, from 0.10 cm³/g to 2.0 cm³/g, from 0.05 cm³/g to 1.5 cm³/g, from 0.06 cm³/g to 1.5 cm³/g, from 0.07 cm³/g to 1.5 cm³/g, from 0.08 cm³/g to 1.5 cm³/g, from 0.09 cm³/g to 1.5 cm³/g, or from 0.10 cm³/g to 1.5 cm³/g. The average micropore volume is determined using BJH analysis.

In embodiments, the ZSM-5 zeolite may have an average total pore volume of greater than or equal to 0.10 cm³/g, such as greater than or equal to 0.15 cm³/g, greater than or equal to 0.20 cm³/g, greater than or equal to 0.25 cm³/g, or greater than or equal to 0.30 cm³/g. In embodiments, the ZSM-5 zeolite may have an average total pore volume of from 0.1 cm³/g to 0.5 cm³/g. For instance, in embodiments, the ZSM-5 zeolite may have an average total pore volume of from 0.2 cm³/g to 0.5 cm³/g, or from 0.3 cm³/g to 0.5 cm³/g. The average total pore volume is determined using BJH analysis.

In embodiments, the ZSM-5 zeolite may be substantially free of phosphorous. As used herein “substantially free of phosphorous” refers to the ZSM-5 zeolite comprising less than 0.001 percent by weight phosphorous, based on the total weight of the ZSM-5 zeolite. In embodiments, the ZSM-5 zeolite may be substantially free of any transition metals. As used herein “substantially free of any transition metals” refers to the ZSM-5 zeolite comprising less than 0.01 percent by weight transition metals, based on the total weight of the ZSM-5 zeolite. In embodiments, the ZSM-5 zeolite may be substantially free of any transition metal oxides. As used herein “substantially free of any transition metal oxides” refers to the ZSM-5 zeolite comprising less than 0.01 percent by weight transition metal oxides, based on the total weight of the ZSM-5 zeolite.

In embodiments, the ZSM-5 zeolite prepared by the methods of the present disclosure may be used in processes for cracking hydrocarbon feeds to produce light olefins, light aromatic compounds, or both. In embodiments, the process of cracking a hydrocarbon feed may include contacting the hydrocarbon feed with steam in the presence of the ZSM-5 zeolite or HZSM-5 zeolite of the present disclosure in a reactor under reaction conditions sufficient to cause at least a portion of the hydrocarbon feed to undergo one or more cracking reactions to produce a cracking effluent comprising light olefins, light aromatic compounds, or both.

In embodiments, the hydrocarbon feed may be a crude oil. As used in the present disclosure, the term “crude oil” refers to a mixture of petroleum liquids and gases, including impurities, such as sulfur-containing compounds, nitrogen-containing compounds, and metal compounds, extracted directly from a subterranean formation or received from a desalting unit without having any fractions, such as naphtha, separated by distillation. In other embodiments, the crude oil may be processed, such as separated by distillation, and the hydrocarbon feed may comprise a processed stream of the crude oil.

In embodiments, the hydrocarbon feed may have an American Petroleum Institute (API) gravity of from 15 degrees to 50 degrees, such as from 20 degrees to 50 degrees, from 25 degrees to 50 degrees, from 30 degrees to 50 degrees, or from 35 degrees to 50 degrees. For example, the hydrocarbon feed 102 may include an extra light crude oil, a light crude oil, a heavy crude oil, or combinations of these. In embodiments, the hydrocarbon feed may be an extra light crude oil, such as but not limited to an Arab extra light export crude oil.

In embodiments, the hydrocarbon feed may comprise from 10 wt. % to 70 wt. % naphtha, based on the total weight of the hydrocarbon feed. For instance, in embodiments, the hydrocarbon feed may comprise from 10 wt. % to 60 wt. %, from 10 wt. % to 50 wt. %, from 10 wt. % to 40 wt. %, from 10 wt. % to 30 wt. %, from 10 wt. % to 20 wt. %, from 20 wt. % to 70 wt. %, from 20 wt. % to 60 wt. %, from 20 wt. % to 50 wt. %, from 20 wt. % to 40 wt. %, from 20 wt. % to 30 wt. %, from 30 wt. % to 70 wt. %, from 30 wt. % to 60 wt. %, from 30 wt. % to 50 wt. %, from 30 wt. % to 40 wt. %, from 40 wt. % to 70 wt. %, from 40 wt. % to 60 wt. %, from 40 wt. % to 50 wt. %, from 50 wt. % to 70 wt. %, from 50 wt. % to 60 wt. %, or from 60 wt. % to 70 wt. % naphtha, based on the total weight of the hydrocarbon feed. As used in the present disclosure, the term “naphtha” refers to an intermediate mixture of hydrocarbon-containing materials derived from crude oil refining and having atmospheric boiling points from 25 degrees Celsius (° C.) to 220° C.

In embodiments, the hydrocarbon feed may comprise from 20 wt. % to 60 wt. % middle distillates, based on the total weight of the hydrocarbon feed. For instance, the hydrocarbon feed may comprise from 20 wt. % to 50 wt. %, from 20 wt. % to 40 wt. %, or from 20 wt. % to 30 wt. % middle distillates, based on the total weight of the hydrocarbon feed. As used in the present disclosure, the term “middle distillates” refers to an intermediate mixture of hydrocarbon-containing materials derived from crude oil refining and having atmospheric boiling points from 221° C. to 343° C.

In embodiments, the hydrocarbon feed may comprise from 10 wt. % to 70 wt. % heavy distillates, based on the total weight of the hydrocarbon feed. For instance, in embodiments, the hydrocarbon feed may comprise from 10 wt. % to 60 wt. %, from 10 wt. % to 50 wt. %, from 10 wt. % to 40 wt. %, from 10 wt. % to 30 wt. %, from 10 wt. % to 20 wt. %, from 20 wt. % to 70 wt. %, from 20 wt. % to 60 wt. %, from 20 wt. % to 50 wt. %, from 20 wt. % to 40 wt. %, from 20 wt. % to 30 wt. %, from 30 wt. % to 70 wt. %, from 30 wt. % to 60 wt. %, from 30 wt. % to 50 wt. %, from 30 wt. % to 40 wt. %, from 40 wt. % to 70 wt. %, from 40 wt. % to 60 wt. %, from 40 wt. % to 50 wt. %, from 50 wt. % to 70 wt. %, from 50 wt. % to 60 wt. %, or from 60 wt. % to 70 wt. % heavy distillates, based on the total weight of the hydrocarbon feed. As used in the present disclosure, the term “heavy distillates” refers to an intermediate mixture of hydrocarbon-containing materials derived from crude oil refining and having atmospheric boiling points of greater than 343° C.

In embodiments, the reactor may include a tank or tubular reactor configured to operate as a batch reactor, a continuous stirred-tank reactor (CSTR), or a plug flow reactor. Example reactors include packed bed reactors such as fixed bed reactors, and fluidized bed reactors. One or more reaction zones may be disposed in a reactor. For example, a packed bed reactor with multiple catalyst beds may have multiple reaction zones, where each reaction zone is defined by the area of each catalyst bed.

In embodiments, a cracking catalyst may comprise the ZSM-5 zeolite produced by the methods of the present disclosure. The cracking catalyst can include the ZSM-5 zeolite or the HZSM-5 zeolite (hydrogen form). In embodiments, the cracking catalyst can consist of or consist essentially of the ZSM-5 zeolite or the HZSM-5 zeolite.

In embodiments, the process may include contacting the hydrocarbon feed with the steam in the presence of the ZSM-5 zeolite or the HZSM-5 zeolite in the reactor for a residence time of from 1 second to 60 seconds, such as from 5 seconds to 30 seconds, or about 10 seconds. In embodiments, the reactor may be operated at a weight hourly space velocity (WHSV) of from 0.1 h⁻¹ to 25 h⁻¹. As used in the present disclosure, the “WHSV” is defined as the weight of the hydrocarbon feed flowing into the reactor per unit weight of the catalyst composition in the reactor per hour. For instance, in embodiments, the reactor may be operated at a weight hourly space velocity (WHSV) of from 0.1 h⁻¹ to 20 h⁻¹, from 0.1 h⁻¹ to 10 h⁻¹, from 0.1 h⁻¹ to 5 h⁻¹, from 1 h⁻¹ to 25 h⁻¹, from 1 h⁻¹ to 20 h⁻¹, from 1 h⁻¹ to 10 h⁻¹, from 1 h⁻¹ to 5 h⁻¹, from 2 h⁻¹ to 25 h⁻¹, from 2 h-1 to 20 h⁻¹, from 2 h⁻¹ to 10 h⁻¹, from 2 h⁻¹ to 5 h⁻¹, or from 2 h⁻¹ to 4 h⁻¹.

In embodiments, water may be injected into the reactor. The water may be converted to steam prior to contacting the hydrocarbon feed or upon contact with the hydrocarbon feed. The water may be delivered to the reactor at a gas hourly space velocity of greater than or equal to 0.1 per hour (h-1), greater than or equal to 0.5 h⁻¹, greater than or equal to 1 h⁻¹, greater than or equal to 5 h⁻¹, greater than or equal to 6 h⁻¹, greater than or equal to 10 h⁻¹, or even greater than or equal to 15 h⁻¹. The water may be introduced to the reactor at a gas hourly space velocity of less than or equal to 100 h⁻¹, less than or equal to 75 h⁻¹, less than or equal to 50 h⁻¹, less than or equal to 30 h 1, or less than or equal to 20 h⁻¹. The water may be introduced to the reactor at a gas hourly space velocity of from 0.1 h⁻¹ to 100 h⁻¹, from 0.1 h⁻¹ to 75 h⁻¹, from 0.1 h⁻¹ to 50 h⁻¹, from 0.1 h⁻¹ to 30 h-1, from 0.1 h⁻¹ to 20 h⁻¹, from 1 h⁻¹ to 100 h⁻¹, from 1 h⁻¹ to 75 h⁻¹, from 1 h⁻¹ to 50 h⁻¹, from 1 h-1 to 30 h⁻¹, or from 1 h⁻¹ to 20 h⁻¹.

The steam produced from injection of the water into the reactor may reduce the hydrocarbon partial pressure, which may have the dual effects of increasing yields of light olefins (e.g., ethylene, propylene and butylene) as well as reducing coke formation on the ZSM-5 zeolite or cracking catalyst comprising the ZSM-5 zeolite. Without intending to be bound by any particular theory, it is believed that light olefins like propylene and mixed butenes are mainly generated from catalytic cracking reactions following the carbonium ion mechanism, and as these are intermediate products, they can undergo secondary reactions such as hydrogen transfer and aromatization (leading to coke formation). The steam may increase the yield of light olefins by suppressing these secondary bi-molecular reactions, and may reduce the concentration of reactants and products, which favor selectivity towards light olefins. The steam may also suppress secondary reactions that are responsible for coke formation on the catalyst surface, which is good for catalysts to maintain high average activation. These factors may show that a large steam-to-oil weight ratio may be beneficial to the production of light olefins.

In embodiments, the reactor may be operated at a temperature of from 500° C. to 700° C., such as from 550° C. to 700° C., from 600° C. to 700° C., or from 650° C. to 700° C.

In embodiments, the product effluent may comprise greater than or equal to 20 wt. % light olefins, based on the total weight of the product effluent. For instance, the product effluent may comprise greater than or equal to 25 wt. %, greater than or equal to 30 wt. %, greater than or equal to 35 wt. %, or even greater than or equal to 37 wt. % light olefins. In embodiments, the product effluent may comprise of from 20 wt. % to 60 wt. % light olefins, such as from 20 wt. % to 50 wt. %, from 20 wt. % to 40 wt. %, from 30 wt. % to 60 wt. %, from 30 wt. % to 50 wt. %, from 30 wt. % to 40 wt. %, from 35 wt. % to 60 wt. %, from 35 wt. % to 50 wt. %, or from 35 wt. % to 40 wt. % light olefins.

Without intending to be bound by any particular theory, it is believed that the ZSM-5 zeolites and cracking catalysts comprising the ZSM-5 zeolites described herein may be used to crack a hydrocarbon feed and produce a product effluent having a greater amount of light olefins compared to methods using conventional catalysts derived from kaolin clay comprising less than 10 wt. % halloysite.

A first aspect of the present disclosure is directed to a method of forming a ZSM-5 zeolite, the method comprising calcining one or more clay mineral compositions to form metakaolin, forming a slurry by combining at least the metakaolin, ZSM-5 zeolite seeds, a basic compound, and a silica source, hydrothermally treating the slurry to form a hydrothermal product, and calcining the hydrothermal product to form the ZSM-5 zeolite. The one or more clay mineral compositions comprise greater than or equal to 10 wt. % halloysite.

A second aspect of the present disclosure may include the first aspect, wherein the one or more clay mineral compositions comprise of from 50 weight percent (wt. %) to 100 wt. % halloysite, based on the total weight of the one or more clay mineral compositions.

A third aspect of the present disclosure may include either one of the first or second aspects, wherein the one or more clay mineral compositions comprise from 0 wt. % to 90 wt. % kaolinite, based on the total weight of the one or more clay mineral compositions.

A fourth aspect of the present disclosure may include any one of the first through third aspects, wherein calcining the one or more clay mineral compositions comprises heating the one or more clay mineral compositions at a temperature of greater than or equal to 500° C.

A fifth aspect of the present disclosure may include any one of the first through fourth aspects, wherein the metakaolin has an average surface area of greater than 30 m²/g.

A sixth aspect of the present disclosure may include any one of the first through fifth aspects, wherein the metakaolin has an average pore volume of greater than 0.15 centimeters cubed per gram (cm³/g).

A seventh aspect of the present disclosure may include any one of the first through sixth aspects, wherein the ZSM-5 zeolite seeds have an average silica to alumina ratio of from 10 to 280.

An eighth aspect of the present disclosure may include any one of the first through seventh aspects, wherein the slurry further comprises a templating agent.

A ninth aspect of the present disclosure may include the eighth aspect, wherein the templating agent comprises an ammonium salt, a poloxamer, or combinations thereof.

A tenth aspect of the present disclosure may include either one of the eighth or ninth aspects, wherein the templating agent comprises tetrapropylammonium bromide.

An eleventh aspect of the present disclosure may include any one of the eighth through tenth aspects, wherein the slurry comprises from 0.1 wt. % to 5 wt. % of the templating agent, based on the total weight of the slurry.

A twelfth aspect of the present disclosure may include any one of the first through eleventh aspects, wherein hydrothermally treating the slurry includes heating the slurry at a temperature of greater than or equal to 100° C.

A thirteenth aspect of the present disclosure may include any one of the first through twelfth aspects, wherein hydrothermally treating the slurry includes heating the slurry at a temperature of greater than or equal to 100° C. for a duration of greater than or equal to 48 hours.

A fourteenth aspect of the present disclosure may include any one of the first through thirteenth aspects, wherein calcining the hydrothermal product comprises heating the hydrothermal product at a temperature of greater than or equal to 400° C.

A fifteenth aspect of the present disclosure may include any one of the first through fourteenth aspects, further comprising ion-exchanging the ZSM-5 zeolite with a solution comprising ammonium nitrate or ammonium acetate to produce a hydrogen form of the ZSM-5 zeolite.

A sixteenth aspect of the present disclosure may include any one of the first through fifteenth aspects, wherein the slurry comprises from 1 wt. % to 3 wt. % of the metakaolin, from 0.01 wt. % to 0.5 wt. % of the ZSM-5 zeolite seeds, from 1 wt. % to 3 wt. % of the basic compound, and from 30 wt. % to 50 wt. % of the silica source, where the weight percentages are based on the total weight of the slurry.

A seventeenth aspect of the present disclosure is directed to a ZSM-5 zeolite prepared by the method of any one of the first through sixteenth aspects.

An eighteenth aspect of the present disclosure may include the seventeenth aspect wherein the ZSM-5 zeolite has an average mesopore volume of greater than or equal to 0.10 cubic centimeters cubed per gram (cm³/g).

A nineteenth aspect of the present disclosure may include any one of the seventeenth aspect or eighteenth aspect, wherein the ZSM-5 zeolite has an average micropore volume of greater than or equal to 0.08 cubic centimeters cubed per gram (cm³/g).

A twentieth aspect of the present disclosure may include any one of the seventeenth through nineteenth aspects, wherein the ZSM-5 zeolite has an average total pore volume of greater than or equal to 0.20 cubic centimeters cubed per gram (cm³/g).

A twenty first aspect of the present disclosure may include any one of the seventeenth through twentieth aspects, where the ZSM-5 zeolite is substantially free of phosphorous, transition metals, and transition metal oxides.

A twenty second aspect of the present disclosure is directed to a process of cracking a hydrocarbon feed comprising contacting the hydrocarbon feed with steam in the presence of a cracking catalyst comprising the ZSM-5 zeolite of any one of the seventeenth through twenty first aspects in a reactor under reaction conditions sufficient to cause at least a portion of the hydrocarbon feed to undergo one or more cracking reactions to produce a cracking effluent comprising light olefins, light aromatic compounds, or both

A twenty third aspect of the present disclosure may the twenty second aspect, wherein the hydrocarbon feed is crude oil.

A twenty fourth aspect of the present disclosure may include any one of the twenty second or twenty third aspects, wherein where the hydrocarbon feed has an American Petroleum Institute gravity of from 15 degrees to 50 degrees

A twenty fifth aspect of the present disclosure may include any one of the twenty second through twenty fourth aspects, comprising contacting the hydrocarbon feed with the steam in the presence of the cracking catalyst at a temperature of from 500° C. to 700° C.

A twenty sixth aspect of the present disclosure may include any one of the twenty second through twenty fifth aspects, comprising contacting the hydrocarbon feed with the steam in the presence of the cracking catalyst for a residence time of from 0.1 seconds to 60 seconds.

A twenty seventh aspect of the present disclosure may include any one of the twenty second through twenty sixth aspects, where the cracking catalyst consists of the ZSM-5 zeolite.

### EXAMPLES

The various embodiments disclosed herein will be further clarified by the following examples. The examples are illustrative in nature, and should not be understood to limit the embodiments disclosed herein.

### Comparative Example A. Preparation of Metakaolin from Kaolinite

In Comparative Example A, metakaolin was prepared by calcining kaolin clay comprising hydrated aluminum silicate (kaolinite). The kaolin clay of Comparative Example A is commercially available as Kaolin (K7375) from Sigma Aldrich. Metakaolin was formed by heating the kaolin clay in an oven at a ramp rate of 5° C./min until reaching 700° C. The sample was calcined for 2 hours at 700° C. to form metakaolin, denoted as Comparative Example A.

### Example 1. Preparation of Metakaolin from Halloysite

In Example 1, metakaolin was prepared by calcining a kaolin clay comprising halloysite. In Examples 1-1, 1-2, and 1-3, the calcining time was varied.

### Example 1-1

To prepare Example 1-1, kaolin clay comprising halloysite was calcined. The kaolin clay of Example 1 is commercially available as halloysite nanoclay (685445) from Sigma Aldrich. Metakaolin was formed by heating naturally occurring kaolin clay comprising halloysite in an oven at a ramp rate of 5° C./min until reaching 700° C. The sample was calcined for 30 min at 700° C. to form metakaolin, denoted as Example 1-1.

### Example 1-2

Example 1-2 was prepared according to Example 1-1, but the sample was calcined for 1 hour at 700° C. to form metakaolin, denoted as Example 1-2.

### Example 1-3

Example 1-3 was prepared according to Example 1-1, but the sample was calcined for 2 hour at 700° C. to form metakaolin, denoted as Example 1-3.

### Comparative Example B. Preparation of ZSM-5 Zeolite from Kaolinite

In Comparative Example B, ZSM-5 zeolites were prepared using metakaolin formed from kaolinite. In particular, the metakaolin was formed according to Comparative Example A.

### Comparative Example B-1

To prepare Comparative Example B-1, an alkaline mixture was prepared by mixing 10 mL of distilled water and 1 gram of sodium hydroxide (NaOH), which was stirred for 20 min. Comparative Example A (1.0 g) was dispersed in deionized water (10 mL) and stirred for 1 hour to form a metakaolin dispersion. The metakaolin dispersion was mixed with the alkaline mixture to form a metakaolin alkaline mixture. Silica particles (Ludox® AS-40 colloidal silica, (Cat. No. 420840), available from Sigma Aldrich) in an amount of 22.83 g were added dropwise to the metakaolin alkaline mixture and stirred for 1 hour to form a metakaolin-nanosilica mixture. The metakaolin-nanosilica mixture was dispersed in deionized water (10 mL) and stirred for 16 hours. An initial ZSM-5 zeolite having a silica to alumina ratio (SAR) of 80 (Product No. CBV 8014 ZSM-5 zeolite, available from Zeolyst International) in an amount of 0.09 g was added to the metakaolin-nanosilica solution mixture to act as seeds that facilitated the zeolite growth, and was stirred for 2 hours. Tetrapropylammonium bromide (TPABr) (0.5 g) was added to the seeded metakaolin-nanosilica mixture to form the slurry, and the slurry was kept at room temperature and not stirred for 12 hours. The slurry was transferred to a Teflon-lined autoclave and aged at 175° C. for 72 hours to obtain the kaolinite-based zeolite. The kaolinite-based zeolite was extracted from the solution by vacuum filtration washed three times with deionized water, and then dried at 100° C. for 12 h. The washed and dried zeolite was calcined at 550° C. for 6 hours. The calcined zeolite was ion exchanged twice using 10 mL of 1M NH₄NO₃ solution per gram of zeolite at 80° C. for 3 hours. The ion-exchanged zeolite was washed and calcined at 500° C. for 2 hours. The final zeolite product is denoted as Comparative Example B-1.

### Comparative Example B-2

Comparative Example B-2 was prepared according to the method described in Comparative Example B-1, but the TPABr was not present in the slurry. The final zeolite is denoted as Comparative Example B-2.

### Example 2. Preparation of ZSM-5 Zeolite from Halloysite

In Example 2. ZSM-5 zeolites were prepared using metakaolin formed from halloysite. In particular, the metakaolin was formed according to the method described in Example 1-3.

### Example 2-1

To prepare Example 2-1, an alkaline mixture was prepared by mixing 10 mL of distilled water and 1 gram of sodium hydroxide (NaOH), which was stirred for 20 min. Example 1-3 (1.0 g) was dispersed in deionized water (10 ml) and stirred for 1 hour to form a metakaolin dispersion. The metakaolin dispersion was mixed with the alkaline mixture to form a metakaolin alkaline mixture. Silica particles (Ludox® AS-40 colloidal silica, (Cat. No. 420840), available from Sigma Aldrich) in an amount of 22.83 g were added dropwise to the metakaolin alkaline mixture and stirred for 1 hour to form a metakaolin-nanosilica mixture. The metakaolin-nanosilica mixture was dispersed in deionized water (10 mL) and stirred for 16 hours. An initial ZSM-5 zeolite having a silica to alumina ratio (SAR) of 80, a surface area of 358 m²/g, and pore volume of 0.22 cm³/g (Product No. CBV 8014 ZSM-5 zeolite, available from Zeolyst International) in an amount of 0.09 g was added to the metakaolin-nanosilica solution mixture to act as seeds that facilitated the zeolite growth, and was stirred for 2 hours. Tetrapropylammonium bromide (TPABr) (0.5 g) was added to the seeded metakaolin-nanosilica mixture to form the slurry, and the slurry was kept at room temperature and not stirred for 12 hours. The slurry was transferred to a Teflon-lined autoclave and aged at 175° C. for 72 hours to obtain the halloysite-based zeolite. The halloysite-based zeolite was extracted from the solution by vacuum filtration washed three times with deionized water, and then dried at 100° C. for 12 h. The washed and dried zeolite was calcined at 550° C. for 6 hours. The calcined zeolite was ion exchanged twice using 10 mL of 1M NH₄NO₃ solution per gram of zeolite at 80° C. for 3 hours. The ion-exchanged zeolite was washed and calcined at 500° C. for 2 hours. The final ZSM-5 zeolite is denoted as Example 2-1.

### Example 2-2

To prepare Example 2-1, an alkaline mixture was prepared by mixing 10 mL of distilled water and 1 gram of sodium hydroxide (NaOH), which was stirred for 20 min. Example 1-3 (1.0 g) was dispersed in deionized water (10 ml) and stirred for 1 hour to form a metakaolin dispersion. The metakaolin dispersion was mixed with the alkaline mixture to form a metakaolin alkaline mixture. Silica particles (Ludox® AS-40 colloidal silica, (Cat. No. 420840), available from Sigma Aldrich) in an amount of 22.83 g were added dropwise to the metakaolin alkaline mixture and stirred for 1 hour to form a metakaolin-nanosilica mixture. The metakaolin-nanosilica mixture was dispersed in deionized water (10 mL) and stirred for 16 hours. An initial ZSM-5 zeolite having a silica to alumina ratio (SAR) of 80 (Product No. CBV 8014 ZSM-5 zeolite, available from Zeolyst International) in an amount of 0.09 g was added to the metakaolin-nanosilica solution mixture to act as seeds that facilitated the zeolite growth, and was stirred for 2 hours. Tetrapropylammonium bromide (TPABr) (0.5 g) was added to the seeded metakaolin-nanosilica mixture to form the slurry, and the slurry was kept at room temperature and not stirred for 12 hours. The slurry was transferred to a Teflon-lined autoclave and aged at 175° C. for 72 hours to obtain the halloysite-based zeolite. The halloysite-based zeolite was extracted from the solution by vacuum filtration washed three times with deionized water, and then dried at 100° C. for 12 h. The washed and dried zeolite was calcined at 550° C. for 6 hours. The calcined zeolite was ion exchanged twice using 10 mL of 1M NH₄NO₃ solution per gram of zeolite at 80° C. for 3 hours. The ion-exchanged zeolite was washed and calcined at 500° C. for 2 hours. The final ZSM-5 zeolite is denoted as Example 2-1.

### Example 2-2

Example 2-2 was prepared according to Example 2-1, but the slurry was aged for 96 hours instead of 72 hours. The ZSM-5 zeolite is denoted as Example 2-2.

### Example 2-3

Example 2-3 was prepared according to Example 2-1, but the slurry was aged for 120 hours instead of 72 hours. The ZSM-5 zeolite is denoted as Example 2-3.

### Example 2-4

Example 2-4 was prepared according to Example 2-1, but the TPABr was not present in the slurry. The ZSM-5 zeolite is denoted as Example 2-4.

### Example 3. Evaluation of Metakaolin Formed from Kaolinite and Halloysite

In Example 3, the metakaolin formed in Comparative Example A and Example 1-3 were characterized to distinguish differences between the metakaolin based on the kaolin material calcined.

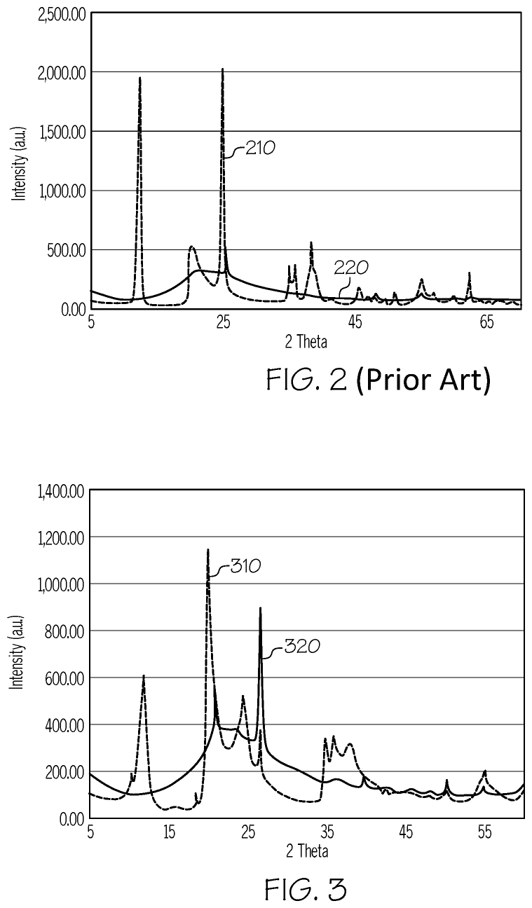

Referring to FIG. 2. X-ray diffraction (XRD) spectra of kaolin clay used in the Comparative Examples 210, and Comparative Example A (metakaolin formed therefrom) 220 are depicted. Referring to FIG. 3, XRD spectra of kaolin clay used in the Examples 310, and Example 1-3 (metakaolin formed therefrom) 320 are depicted. The characteristic peaks of kaolin clays disappeared after calcination indicating the successful conversion of kaolin clay to metakaolin. For example, FIG. 3 shows the characteristic peaks of halloysite clay at 2θ=11.8°, 19.9°, 24.8°, 35°, 36°, 38.3°, and 55.2°. After calcination, the characteristic peaks disappeared into a broad band with a sharp peak at 26.7°. These results show that calcining the kaolin clay (both kaolin clay of the comparative examples and kaolin clay of the Examples) leads to structural changes from crystalline kaolin clay to form amorphous metakaolin.

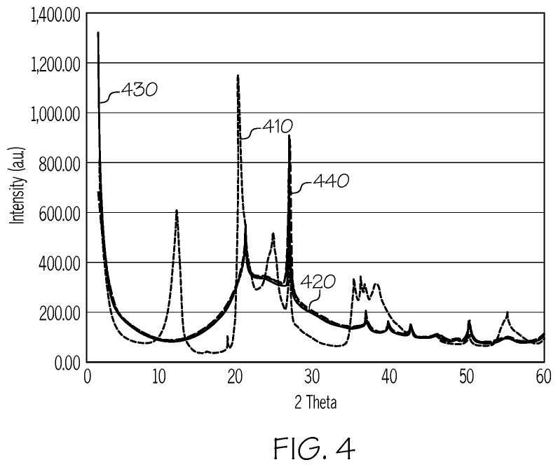

Referring to FIG. 4, X-ray diffraction (XRD) spectra of kaolin clay used in the Examples 410, and metakaolin derived therefrom of Example 1-1 420, Example 1-2 430, and Example 1-3 440 are depicted. As demonstrated in FIG. 4, the structural change of the kaolin clay 410 to metakaolin occurred after a calcination time of 30 min (Example 1-1 420).

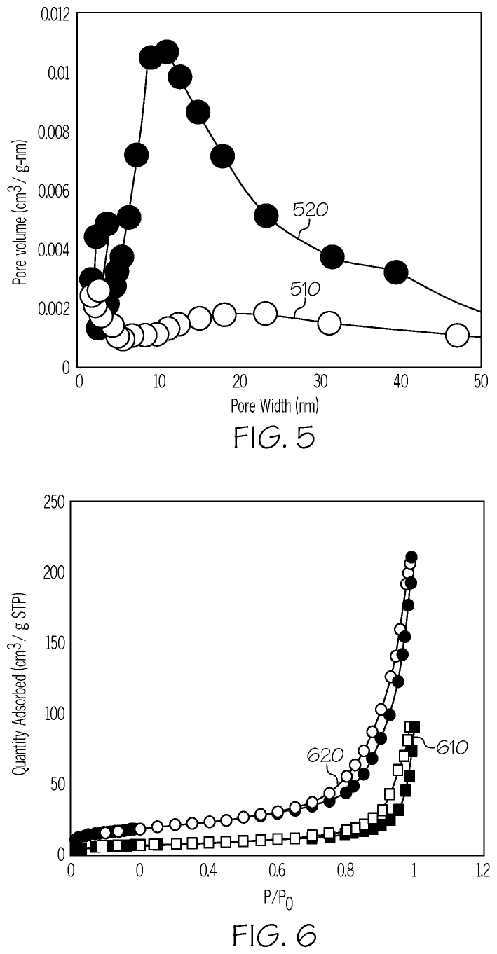

Referring to FIG. 5, pore volume (y-axis) as a function of pore width (x-axis) of Comparative Example A and Example 1-3 is depicted. Referring to FIG. 6, the nitrogen adsorption-desorption isotherms of Comparative Example A and Example 1-3 is depicted. Textural characteristics involving surface area and pore size distributions of parent and formulations were measured using an ASAP™ 2020 plus adsorption analyzer (Micromeritics, USA). The samples were pretreated before measurements at 523 K for 2 hours (h). The surface area and pore sizes were calculated using BET and BJH techniques. The surface area was evaluated by considering adsorption values of linear plots for BET. Pore volume was obtained at p/p0=0.98, while micropore surface area was calculated based on t-plot technique. FIG. 5 shows that Comparative Example A 510 has a pore volume of 0.11 cm³/g, whereas Example 1-3 520 has a pore volume of 0.32 cm³/g. FIG. 6 shows that Comparative Example A 610 has a surface area of 23 m²/g, whereas Example 1-3 620 has a surface area of 64 m²/g. Example 1-3 demonstrated mesoporous surface characteristics with a type IV isotherm with H3 hysteresis. These results demonstrate that metakaolin formed from kaolin clay comprising halloysite provides increased surface area and pore volume in comparison to metakaolin formed from kaolin clay comprising kaolinite.

### Example 4. Evaluation of Metakaolin and ZSM-5 Zeolites Formed from Kaolinite and Halloysite

Further, the surface areas, pore volumes, and pore distributions of the Examples and Comparative Examples were measured, and are summarized in Table 1. A t-plot was used to differentiate microporous and mesoporous surface area. MicroSA refers to the microporous surface area. MicroPV refers to the microporous pore volume. MesoPV refers to the mesoporous pore volume. PSD refers to the pore size distribution.

TABLE 1

| | Surface | Mi- | Pore | | | |
|---|---|---|---|---|---|---|
| | area | croSA | Volume | MicroPV | MesoPV | PSD |
| Sample | (m²/g) | (m²/g) | (cm³/g) | (cm³/g) | (cm³/g) | (nm) |
| Comparative | 23 | 0.5 | 0.11 | — | 0.11 | 20.2 |
| Example A | | | | | | |
| Example 1-3 | 77 | 0.6 | 0.34 | — | 0.34 | 17.7 |
| Comparative | 168 | 123 | 0.18 | 0.07 | 0.11 | 4.22 |
| Example B-1 | | | | | | |
| Comparative | 257 | 161 | 0.17 | 0.09 | 0.08 | 2.67 |
| Example B-2 | | | | | | |
| Example 2-1 | 264 | 191 | 0.21 | 0.11 | 0.10 | 3.20 |
| Example 2-3 | 387 | 282 | 0.34 | 0.16 | 0.18 | 3.5 |
| Example 2-4 | 275 | 161 | 0.17 | 0.09 | 0.08 | 2.67 |

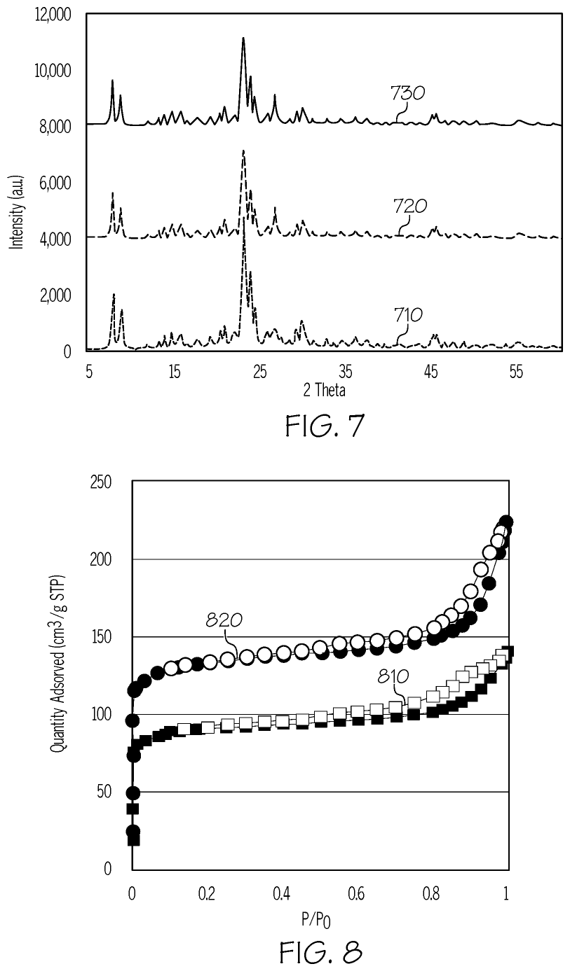

Referring to FIG. 7, XRD spectra of Example 2-1 710, Example 2-2 720, and Example 2-3 730 are depicted and demonstrate the influence of aging time of the slurry on the surface characteristics of the halloysite-based zeolite. The crystallinity of Example 2-2 720 and Example 2-3 730 were evaluated with reference to the peak height (100% of peak between 22-25°) of Example 2-1 710 (72 hr aging). FIG. 7 shows the crystallinity of Example 2-2 720 (96 hr aging) and Example 2-3 730 (120 hr aging) were 50% and 49%, respectively, relative to Example 2-1 710. Such a reduction in crystallinity corresponding to an increased aging time of the slurry may be correlated to increased amorphous characteristics and increased generation of mesopores in the formed zeolite.

Referring to FIG. 8, the nitrogen adsorption-desorption isotherms provided the surface areas, pore volumes, and pore distributions of Example 2-1 810 and Example 2-3 820 and demonstrate the influence of aging time of the slurry on the textural characteristics of the halloysite-based zeolite. Textural characteristics involving surface area and pore size distributions of the examples were measured using an ASAP™ 2020 plus adsorption analyzer (Micromeritics, USA). The samples were pretreated before measurements at 523 K for 2 h. The surface area and pore sizes were calculated using BET and BJH techniques. The surface area was evaluated by considering adsorption values of linear plots for BET. Pore volume was obtained at p/p0=0.98, while micropore surface area was calculated based on t-plot technique. Example 2-1 has a pore volume of 0.21 cm³/g, whereas Example 2-3 has a pore volume of 0.34 cm³/g. FIG. 8 shows that Example 2-1 810 (72 hr aging) has a surface area and micropore surface area of 264 m²/g and 191 m²/g, respectively. Example 2-3 820 (120 hr aging) has a surface area and micropore surface area of 387 m²/g, and 282 m²/g. These results demonstrate that increased aging time of the slurry can increase the micropores and mesopores of the halloysite-based zeolite.

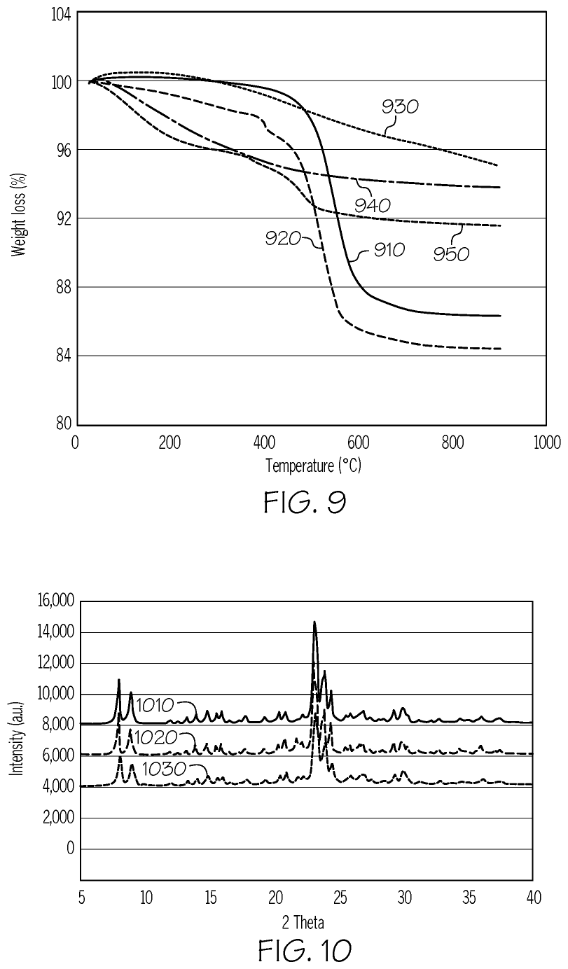

Referring to FIG. 9, thermogravimetric analysis for kaolin clay comprising kaolinite 910, kaolin clay comprising halloysite 920, Comparative Example A 930, Example 1-3 940, and Example 2-1 950 are depicted between 100° C. to 900° C. FIG. 9 shows that a two-stage weight loss occurred when heating the kaolinite clay 910 and the halloysite clay 920 from 100° C. to 900° C. The first-stage weight loss at a temperature below 200° C. is attributed to the desorption of water molecules. The second-stage weight loss at a temperature above 400° C. is attributed to dehydroxylation indicating the Al—OH group rearrangement and structural change during the conversion of kaolin to metakaolin. The results show that halloysite clay (920) and Example 1-3 (940) had larger weight loss (16% and 6.2%, respectively) than kaolinite clay (910) and Comparative Example A (930) (14% and 4.9%, respectively). Additionally, Example 2-1 (950), the zeolite synthesized from metakaolin of Example 1-3, which used a tetrapropylammonium bromide template, had a total weight loss of 8.4%. The template degradation can be observed followed by the dehydroxylation process. The results confirm that the conversion of halloysite clay to metakaolin involves unique, high structural Al—OH group rearrangement compared to the conversion of kaolinite clay.

Referring to FIG. 10, XRD spectra of a ZSM-5 reference and various Comparative Examples and Examples are depicted. The crystallinity of sample was evaluated with reference to the peak height (100% of peak between) 22-25° of a commercial ZSM-5 zeolite 1010 (ZSM-5-23, Zeolyst International, Cat. No. CBV 2314). FIG. 10 shows the crystallinity of Comparative Example B-1 1020 and Example 2-1 1030 were 92% and 71%, respectively. Such a reduction in crystallinity, in particular with Example 2-1 may be correlated to the amorphous characteristics with introduction of metakaolin source during hydrothermal synthesis. A reduced XRD pattern may also occur due to smaller crystal size of ZSM-5. The results obtained using BET surface area in Example 4 agree with the presence of mesopores and micropores indicating the nanosize transformation using kaolin clay comprising halloysite.

Ammonia temperature programmed desorption (NH₃-TPD) analysis was carried out to characterize the acid strength of the Examples and Comparative Examples. Typically, two desorption peaks in the range of 100-300° C. and above 350° C. were observed in all the analyzed samples. A low desorption peak between 100-300° C. corresponds to weak acid sites (almost Lewis), while high temperature desorption between 400-550° C. is ascribed to strong acid sites (almost Bronsted). A summary of the results is presented in Table 2.

TABLE 2

| | Amount of NH₃ | | |
|---|---|---|---|
| | desorbed (mmol/g) | | |
| | 100- | Above | |
| Sample | 350° C. | 350° C. | Total acidity |
| Example 1-3 | 0.012 | — | 0.012 |
| Example 2-1 | 0.132 | 0.126 | 0.258 |
| Comparative Example B-2 | 0.118 | 0.105 | 0.223 |

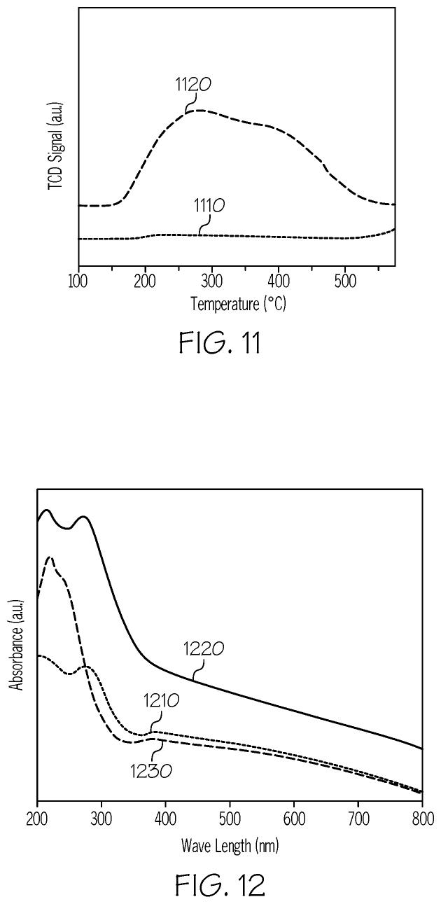

Referring to FIG. 11, the thermal conductivity detector (TCD) intensity of Example 1-3 1110 showed very weak desorption peak at around 100-300° C., which indicates that the metakaolin formed from kaolinite has small weak acid sites (0.012 mmol/g as presented in Table 2). The spectrum of Example 2-1 1120 showed high NH₃ desorption peaks with integrated peak areas of 0.132 mmol/g and 0.126 mmol/g mmol/g corresponding to weak and strong acid sites respectively. This implies that the synthesis of ZSM-5 using kaolin comprising halloysite is a cost effective and environmentally friendly alternative for the synthesis of high acid strength ZSM-5 zeolite, while maintaining or improving zeolite function.

Referring to FIG. 12, diffuse reflectance spectra of commercial ZSM-5-23 1210, Comparative Example B-2 1220, and Example 2-1 1230 are depicted. Commercial ZSM-5-23 1010 showed an absorption band at approximately 217 nm, which is primarily attributed to the charge transfer band indicating the presence of Al in tetrahedral coordination. Another intense peak appears with peak maxima at 275 nm, corresponding to the extra-framework Al species. Comparative Example B-2 1220, which was synthesized without template using metakaolin derived from kaolinite showed more intense two absorption bands compared to ZSM-5-23 1210. It is possible that that presence of Al—O—Si species in paired and isolated form increases the intensity of UV-visible absorption bands. Such an intense absorption indicates an effective insertion of Al in to the MFI framework. For instance, the presence of an intense peak at 211 nm and 267 nm signals in 1220 indicates such paired and isolated Al—O—Si—O—Al species. Example 2-1 1230 showed an intense peak of framework tetrahedral Al species higher than extraframework species. Such peak intensity demonstrates the difference of Al environment in Example 2-1 compared to commercial ZSM-5-23 1210 Comparative Example B-2 1220.

### Example 5. Evaluation of Catalyst Performance for Cracking of Crude Oil Using ZSM-5 Zeolites

Referring to FIG. 13, Arabian extra light (AXL) crude oil 1301 was fed to a fixed-bed reactor 1300 using a metering pump 1311. The composition of the AXL feedstock is summarized in Table 3. A constant feed rate of 2 g/h of AXL crude oil 1301 was used. Water 1302 was fed to the reactor 1300 using a metering pump 1312. Water 1302 was preheated using a preheater 1321. A constant feed rate of 1 g/h of water 1302 was used. Nitrogen 1303 was used as a carrier gas at 65 mL/min. Nitrogen 1303 was fed to the reactor 1300 using a Mass Flow Controller (MFC) 1313. Nitrogen 1303 was preheated using a preheater 1322. Water 1302 and Nitrogen 1303 were mixed using a mixer 1330 and the mixture was introduced to the reactor 1300. Prior to entering the reactor tube, oil, water, and nitrogen were preheated up to 250° C. in the pre-heating zone 1342. The pre-heating zone 1342 was pre-heated using line heaters 1331. Crude oil 1301 was introduced from the top of the reactor 1300 through the injector 1341 and mixed with steam in the top two-third of the reactor tube 1340 before reaching the catalyst bed 1344. The mass ratio of steam:oil was 0.5. The crude oil was cracked at a cracking temperature of 675° C. and a weight ratio of catalyst to oil of 1:2. 1 g of catalyst of 30-40 mesh size were placed at the center of the reactor tube 1340, supported by quartz wool 1343, 1346 and a reactor insert 1345. Quartz wool 1343, 1346 were placed both at the bottom and top of the catalyst bed 1344 to keep it in position. The height of the catalyst bed 1344 was 1-2 cm. The reaction was allowed to take place for 45-60 min, until steady state was reached. Reaction conditions of the fixed-bed flow reactor 1300 are listed in Table 4. The cracking reaction product stream was introduced to a gas-liquid separator 1351. A Wet Test Meter 1352 was placed downstream of the gas-liquid separator 1351. The cracked gaseous products 1361 and liquid products 1362 were characterized by off-line gas chromatographic (GC) analysis using simulated distillation and naphtha analysis techniques. As used herein, “catalyst” can refer to both ZSM-5 zeolites and cracking catalysts comprising ZSM-5 zeolites described in this disclosure. Unless specified otherwise, all catalytic experiments of Example 8 were carried out under the same conditions described herein.

TABLE 3

| Composition | AXL Feed |
|---|---|
| Naphtha | 40.8 |
| Middle Distillates | 26.3 |
| Heavy Distillates | 32.9 |

TABLE 4

| Conditions | |
|---|---|
| Feed Used | AXL Whole Crude |
| Specific gravity of feedstock | 0.829 |
| API | 39.3 |
| Reaction apparatus | Fixed Bed Reactor |
| Weight hourly space velocity, h⁻¹ | 3 |
| Reaction temperature, ° C. | 675 |
| Reaction temperature Range, ° C. | 600-700 |
| Steam:oil ratio | 0.5 |
| Residence time, seconds | 10 |

The reaction product streams from the cracking reaction over various zeolites were analyzed. The yield analysis for commercial zeolites ZSM-5 (23) and ZSM-5 (80), Example 2-1, and Comparative Examples B-1 and B-2 are listed in Table 5. As shown, Example 2-1 had the highest conversion yield of ethylene (19.2 wt. %) and propylene (18.1 wt. %) compared to the commercial ZSM-5 (23) catalyst (CBV 2314, Zeolyst International) and ZSM-5 (80) (CBV 8014, Zeolyst International) catalysts. Example 2-1 also had a higher total yield of ethylene and propylene (C27+C3=) (37.3 wt. %) compared to that Comparative Example B-1 and Comparative Example B-2 (36.1 wt. % and 36.7 wt. %, respectively). These results demonstrate that zeolites derived from kaolin clay comprising halloysite can provide improved catalytic cracking compared to conventional zeolites.

TABLE 5

| | ZSM- | ZSM- | Example | Comp. | Comp. |
|---|---|---|---|---|---|
| Catalyst | 5(23) | 5(80) | 2-1 | Ex. B-1 | Ex. B-2 |
| Mass balance, % | 102 | 101 | 102 | 96 | 101 |
| Conversion, % | 62.5 | 64.5 | 66.8 | 66.5 | 66.2 |

Product Yields, wt. %

| | | | | | |
|---|---|---|---|---|---|
| H₂ | 0.74 | 0.64 | 0.85 | 1.00 | 0.80 |
| C₁ | 7.9 | 7.7 | 7.9 | 8.4 | 8.4 |
| C₂⁼ | 18.0 | 15.8 | 19.2 | 19.4 | 19.8 |
| C₂ | 3.8 | 4.6 | 3.4 | 3.8 | 3.8 |
| C₃ | 0.72 | 0.82 | 0.76 | 0.85 | 0.77 |
| C₃⁼ | 15.7 | 17.1 | 18.1 | 16.7 | 16.9 |
| C₄⁼ | 9.1 | 8.2 | 9.3 | 7.6 | 8.4 |
| iC₄ | 0.055 | 0.060 | 0.021 | 0.101 | 0.102 |
| nC₄ | 0.148 | 0.245 | 0.224 | 0.371 | 0.408 |
| Total gas | 56.3 | 55.1 | 59.8 | 58.3 | 59.4 |
| Naphtha | 25.7 | 22.5 | 22.6 | 23.3 | 24.3 |
| LCO | 8.0 | 8.2 | 7.3 | 7.1 | 6.9 |
| HCO | 3.8 | 4.7 | 3.3 | 3.1 | 2.5 |
| Coke | 6.2 | 9.4 | 7.0 | 8.3 | 6.9 |
| C₂⁼ + C₃⁼ | 33.8 | 32.9 | 37.3 | 36.1 | 36.7 |
| H₂-C₂ (dry gas) | 30.5 | 28.7 | 31.3 | 32.6 | 32.7 |
| C₂⁼ − C₄⁼ | 42.9 | 41.1 | 46.6 | 43.8 | 45.2 |
| C₃-C₄ (LPG) | 25.8 | 26.4 | 28.5 | 25.6 | 26.6 |
| CMR* | 225.0 | 477.8 | 581.4 | 130.9 | 127.1 |
| P/E** | 0.9 | 1.1 | 0.9 | 0.9 | 0.9 |
| C1-C4 | 12.6 | 13.4 | 12.3 | 13.5 | 13.4 |
| LPG olefins | 24.9 | 25.3 | 27.5 | 24.3 | 25.4 |
| LPG olefinicity | 96.4 | 95.7 | 96.5 | 94.9 | 95.2 |

*CMR = (dry gas/iC₄).
**P/E = C₃⁼/C₂⁼.

The reaction product streams from the cracking reaction over a comparative catalyst and Examples 2-1, 2-2, and 2-3 in combination with Ecat (Equilibrium catalyst, W.R. Grace & Co-Conn) were analyzed. Examples 2-1, 2-2, and 2-3 were steam deactivated at 810° C. for 6 hr before using in the reactor. In Example 5-1, 5-2, and 5-3, 75 wt. % Ecat and 25 wt. % of Examples 2-1, 2-2, and 2-3, respectively were loaded in the reactor. Comparative Example 5-A is commercial catalyst (UMIX75, W.R. Grace & Co-Conn) comprising 75 wt. % equilibrium catalyst (Ecat) with USY zeolite and 25 wt. % OlefinsUltra® provided by W. R. Grace & Co-Conn. Table 6 provides the summarized results of the reaction product streams from the cracking reaction. As shown, these results demonstrate that cracking the AXL oil over Examples 5-1, 5-2, and 5-3 had a higher yield of ethylene, propylene, and butylene compared to Comparative Example 5-A.

TABLE 6

| | | | | |
|---|---|---|---|---|
| | | | | Comp. |
| Catalyst | Ex. 5-1 | Ex. 5-2 | Ex. 5-3 | Ex.5-A |

Product Yields, wt. %

| | | | | |
|---|---|---|---|---|
| Fuel gas | 9.8 | 9.3 | 9.4 | 7.7 |
| (C1 + H2) | | | | |
| Saturated | 4.9 | 6.4 | 5.8 | 3.9 |
| C2-C4 | | | | |
| C2= | 21.7 | 19.8 | 20.5 | 18.4 |
| C3= | 17.8 | 18.6 | 19.2 | 18.0 |
| C4= | 7.6 | 7.7 | 8.0 | 8.7 |
| Naphtha | 22.7 | 21.6 | 19.6 | 22.3 |
| Middle | 6.4 | 8.1 | 8.1 | 7.0 |
| Distillates | | | | |
| Heavy | 2.4 | 3.8 | 3.8 | 4.3 |
| Distillates | | | | |
| Coke | 6.7 | 4.7 | 5.6 | 9.7 |

It is noted that one or more of the following claims utilize the term “where” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

What is claimed is:

1. A method of forming a ZSM-5 zeolite, the method comprising:
calcining one or more clay mineral compositions to form metakaolin, wherein the one or more clay mineral compositions comprise greater than or equal to 10 wt. % halloysite;
forming a slurry by combining at least the metakaolin, ZSM-5 zeolite seeds, a basic compound, and a silica source;
hydrothermally treating the slurry to form a hydrothermal product; and
calcining the hydrothermal product to form the ZSM-5 zeolite.

2. The method of claim 1, wherein the one or more clay mineral compositions comprise of from 50 weight percent (wt. %) to 100 wt. % halloysite, based on the total weight of the one or more clay mineral compositions.

3. The method of claim 1, wherein the one or more clay mineral compositions comprise from 0 wt. % to 90 wt. % kaolinite, based on the total weight of the one or more clay mineral compositions.

4. The method of claim 1, wherein the metakaolin has an average surface area of greater than 30 m²/g.

5. The method of claim 1, wherein the metakaolin has an average pore volume of greater than 0.15 centimeters cubed per gram (cm³/g).

6. The method of claim 1, wherein the ZSM-5 zeolite seeds have an average silica to alumina ratio of from 10 to 280.

7. The method of claim 1, wherein the slurry further comprises a templating agent.

8. The method of claim 7, wherein the templating agent comprises an ammonium salt, a poloxamer, or combinations thereof.

9. The method of claim 1, wherein hydrothermally treating the slurry includes heating the slurry at a temperature of greater than or equal to 100° C.

10. The method of claim 1, wherein hydrothermally treating the slurry includes heating the slurry at a temperature of greater than or equal to 100° C. for a duration of greater than or equal to 48 hours.

11. The method of claim 1, wherein calcining the hydrothermal product comprises heating the hydrothermal product at a temperature of greater than or equal to 400° C.

12. The method of claim 1, further comprising ion-exchanging the ZSM-5 zeolite with a solution comprising ammonium nitrate or ammonium acetate to produce a hydrogen form of the ZSM-5 zeolite.

13. The method of claim 1, wherein the slurry comprises:
from 1 wt. % to 3 wt. % of the metakaolin;
from 0.01 wt. % to 0.5 wt. % of the ZSM-5 zeolite seeds;
from 1 wt. % to 3 wt. % of the basic compound; and
from 30 wt. % to 50 wt. % of the silica source, where the weight percentages are based on the total weight of the slurry.

14. A ZSM-5 zeolite prepared by the method of claim 1.

15. The ZSM-5 zeolite of claim 14, wherein the ZSM-5 zeolite has an average mesopore volume of greater than or equal to 0.10 cubic centimeters cubed per gram (cm³/g).

16. The ZSM-5 zeolite of claim 14, wherein the ZSM-5 zeolite has an average micropore volume of greater than or equal to 0.08 cubic centimeters cubed per gram (cm³/g).

17. A process of cracking a hydrocarbon feed comprising contacting the hydrocarbon feed with steam in the presence of a cracking catalyst comprising the ZSM-5 zeolite of claim 14 in a reactor under reaction conditions sufficient to cause at least a portion of the hydrocarbon feed to undergo one or more cracking reactions to produce a cracking effluent comprising light olefins, light aromatic compounds, or both.

18. The process of claim 17, wherein the hydrocarbon feed is crude oil.

19. The process of claim 17, comprising contacting the hydrocarbon feed with the steam in the presence of the cracking catalyst at a temperature of from 500° C. to 700° C.

20. The process of claim 17, where the cracking catalyst consists of the ZSM-5 zeolite.
